(19) United States
(12) Patent Application Publication
(10) Pub. No.: US 2020/0339808 A1
(43) Pub. Date: Oct. 29, 2020

(54) ADHESIVES

(71) Applicant: Covestro Deutschland AG, Leverkusen (DE)

(72) Inventors: Harald KRAUS, Leverkusen (DE); Wolfgang ARNDT, Dormagen (DE); Evgeny AVTOMONOV, Leverkusen (DE)

(21) Appl. No.: 16/962,700

(22) PCT Filed: Jan. 15, 2019
(86) PCT No.: PCT/EP2019/050957

§ 371 Date: Jul. 16, 2020

(30) Foreign Application Priority Data
Jan. 18, 2018 (EP) 18152249.1

(51) Int. Cl. C08L 75/06; C08G 18/08; C08G 18/42; C08G 18/34; C08G 18/72; C09J 175/06

(52) U.S. Cl. CPC C08L 75/06; C08G 18/0866; C08G 18/4238; C08G 2170/80; C08G 18/722; C09J 175/06; C08G 18/341

(57) ABSTRACT

The invention relates to dispersion adhesives based on aqueous polyurethane or polyurethane-urea dispersions, which meet the requirements for industrial shoe manufacturing, in particular with simultaneous drying and activation at low temperatures, and also to the use of the dispersion adhesives for the production of adhesive composites.

The invention relates to aqueous adhesives based on aqueous polyurethane or polyurethane-urea dispersions comprising pentamethylene diisocyanate (PDI), to a process for the preparation thereof, and also to the use of the dispersion adhesives for producing adhesive composites.

Adhesives based on aqueous polyurethane dispersions have become established worldwide in demanding industrial applications, for example in the case of shoe manufacturing, the bonding of parts for motor vehicle interiors, sheet lamination or bonding of textile substrates. The production of aqueous polyurethane or polyurethane-polyurea dispersions is known.

In the case of the use of such dispersions for bonding substrates, this is usually carried out after the heat-activation process. In this case, the dispersion is applied to the substrate and, after completion of evaporation of the water, the adhesive layer is activated by heating (e.g. using an infrared radiator) and melting of the semicrystalline polymer, and is converted into an adhesive state. The temperature at which the adhesive film is sticky is referred to as the activation temperature. Therefore, the present invention also relates to a process for adhesive bonding of substrates in which a preparation according to the invention for producing an adhesive layer is applied to the substrate(s) to be bonded; after completion of evaporation of the water the adhesive layer thus obtained is activated by heating to at least the activation temperature of the layer and melting of the semicrystalline polymer and the substrate(s) are then joined. It is also possible, after generating the adhesive layer in one step, to join the substrates using high pressing pressures and at the same time to activate the adhesive layer by heating to at least the activation temperature, for example in heatable presses.

Short drying times at lowest possible temperatures and low activation temperatures would enable the most efficient, cost-effective and energy-sparing process possible.

In industrial shoe manufacturing, very many are worked by hand. After drying and heat activation of the adhesive, the sole and the upper are firstly assembled by hand and then pressed. More requirements of the adhesive arise therefrom: pronounced stickiness in the activated state (high tack), maintenance of the stickiness over a period of several minutes, high strength at the lowest possible pressing pressures and good initial strength.

Adhesives based on aqueous polyurethane or polyurethane-polyurea dispersions are described by way of example in U.S. Pat. No. 4,870,129. These comprise as isocyanates a mixture of 1-isocyanato-3,3,5-trimethyl-5-isocyanatomethylcyclohexane (isophorone diisocyanate, IPDI) and hexamethylene diisocyanate (HDI) and are suitable in principle for application of the heat activation process.

A disadvantage of these adhesives, however, is that although they provide very good adhesive composites at activation temperatures around 70° C., at low activation temperatures around 50° C. they exhibit unsatisfactory tack values for shoe manufacturing, wherein both the strength and the duration of the stickiness are insufficient. Tack refers to the ability of a material to form an appreciable adhesion at low contact pressure and short contact time.

Adhesives based on aqueous polyurethane-polyurea dispersions comprising only hexamethylene diisocyanate (HDI) as isocyanate component have improved tack values after activation at low temperatures, but they lose this property on storage of the dispersion at low temperatures below 10° C.

The object of the present invention consisted of providing dispersion adhesives based on aqueous polyurethane or polyurethane-urea dispersions, which meet the requirements specified for industrial shoe manufacturing, and have comparably good tack values with simultaneous drying and activation at low temperatures around 50° C. in comparison with adhesives based on purely hexamethylene diisocyanate, but where these values should be obtained even after storage of the dispersions at low temperatures below 10° C. This requirement is of major relevance in this respect since dispersion adhesives in winter and in colder regions are often transported and stored at these temperatures.

It could be shown that semicrystalline adhesives based on aqueous polyurethane or polyurethane-polyurea dispersions, the polymers of which comprise as isocyanate component only hexamethylene diisocyanate (HDI), pentamethylene diisocyanate (PDI) or mixtures of HDI and PDI, which meet the requirements for industrial shoe manufacturing and with simultaneous drying and activation at low temperatures around 50° C., have outstanding tack values. It has however been found that, completely surprisingly, that this property after cold storage at temperatures between 3° C. and 10° C. is lost if the HDI content is >50 mol %, but not at a PDI content of at least 50 mol %.

The present invention therefore relates to preparations based on aqueous polyurethane or polyurethane-urea dispersions comprising a corresponding polymer, that is to say a polyurethane or a polyurea or mixed polymers of these, composed of
A) at least one crystalline or semicrystalline difunctional polyester polyol having a number-average molecular weight of at least 400 g/mol and a melting temperature of at least 40° C. and a heat of fusion of at least 20 J/g,
B) optionally at least one Bifunctional polyol component having a number-average molecular weight of 62 to 399 g/mol,
C) an isocyanate component consisting of pentamethylene diisocyanate or a mixture of pentamethylene diisocyanate and hexamethylene diisocyanate with at least 50 mol % pentamethylene diisocyanate,
D) at least one component reactive to isocyanate bearing at least one ionic or potentially ionic group,
   and
E) optionally further components reactive to isocyanate
   characterized in that the polymer after drying is crystalline or semicrystalline and has a melting temperature of at least 40° C. and a heat of fusion of at least 10 J/g.

The present invention also relates to the use of these preparations as heat-activated adhesives.

The aqueous dispersions according to the invention comprise 15 to 60% by weight polymer and 40 to 85% by weight water, preferably 30 to 50% by weight polymer and 50 to 70% by weight water, particularly preferably 40 to 50% by weight polymer and 50 to 60% by weight water.

The polymer comprises 50 to 95% by weight of constituent A), 0 to 10% by weight of constituent B), 4 to 25% by weight of constituent C), 0.5 to 10% by weight of constituent D) and 0 to 30% by weight of constituent E), wherein the sum total of the constituents adds up to 100% by weight.

In a preferred form of the invention, the polymer comprises 65 to 92% by weight of constituent A), 0 to 5% by weight of constituent B), 6 to 15% by weight of constituent C), 0.5 to 5% by weight of constituent D) and 0 to 25% by weight of constituent E), wherein the sum total of the constituents adds up to 100% by weight.

In a particularly preferred form of the invention, the polymer comprises 75 to 92% by weight of constituent A), 0 to 5% by weight of constituent B), 8 to 15% by weight of constituent C), 0.5 to 4% by weight of constituent D) and 0 to 15% by weight of constituent E), wherein the sum total of the constituents adds up to 100% by weight.

In an especially preferred form of the invention, the polymer comprises 80 to 90% by weight of constituent A), 0 to 3% by weight of constituent B), 8 to 14% by weight of constituent C), 0.5 to 3% by weight of constituent D) and 0 to 10% by weight of constituent E), wherein the sum total of the constituents adds up to 100% by weight.

Suitable as crystalline or semicrystalline difunctional aliphatic polyester polyols A) are polyester polyols based on linear dicarboxylic acids and/or derivatives thereof such as anhydrides, esters or acid chlorides and preferably aliphatic linear polyols. Suitable dicarboxylic acids are, for example adipic acid, succinic acid, sebacic acid or dodecanedioic acid. Preference is given to succinic acid, adipic acid and sebacic acid, particular preference being given to succinic acid and adipic acid and very particular preference being given to adipic acid. These are used in amounts of at least 90 mol %, preferably from 95 to 100 mol %, based on the total amount of all carboxylic acids.

The difunctional polyester polyols A) can be prepared, for example, by polycondensation of dicarboxylic acids with polyols. The polyols preferably have a molar weight of 62 to 399 g/mol, consist of 2 to 12 carbon atoms, are preferably unbranched, difunctional and preferably have primary OH groups.

Preferred polyol components for the polyester polyols A) are butanediol-1,4 and hexanediol-1,6, particularly preferably is butanediol-1,4.

The polyester polyols A) can be constructed from one or more polyols; in a preferred embodiment of the present invention they are constructed from only one polyol.

If the crystalline or semicrystalline Bifunctional polyester polyols having a number-average molecular weight of at least 400 g/mol and a melting temperature of at least 40° C. have a heat of fusion of at least 20 J/g, then the polymer produced using the same regularly has a heat of fusion of at least 10 J/g. If desired, adjustment of the heat of fusion of the polymer can be achieved by a slight modification of the polyester polyol A) content in the composition or by a small variation of the heat of fusion of the polyester polyol. This measure requires only exploratory experiments and is completely within the practical experience of a person of average skill in the art in this field.

The preparation of polyester polyols A) is known from the prior art.

The number-average molecular weight of the polyester polyols A) is between 400 and 4000 g/mol, preferably between 1000 and 3000 g/mol, particularly preferably between 1500 and 2500 g/mol, especially preferably between 1800 and 2400 g/mol.

The melting temperature of the crystalline or semicrystalline polyester polyols is at least 40° C., preferably between 40 and 80° C., particularly preferably between 42 and 60° C. and especially preferably between 45 and 52° C. The heat of fusion is at least 20 J/g, preferably at least 25 J/g and particularly preferably at least 40 J/g.

Suitable as difunctional polyol component B) having a number-average molecular weight of 62 to 399 g/mol are preferably aliphatic or cycloaliphatic, linear or branched polyols. Particularly preferred components B) are monoethylene glycol, propanediol-1,3, propanediol-1,2, butanediol-1,4 or hexanediol-1,6. Particularly preferred are butanediol-1,4 and hexanediol-1,6, very particular preference being to butanediol-1,4.

Pentamethylene diisocyanate is suitable as isocyanate component C). Further suitable are mixtures of pentamethylene diisocyanate and hexamethylene diisocyanate having a pentamethylene diisocyanate content of at least 50 mol %. The isocyanate component C) may comprise further diisocyanates to a low degree. The isocyanate component C) preferably comprises <5 mol % further diisocyanates but particularly preferably the isocyanate component C) does not comprise any further diisocyanates.

Preferred components D) reactive to isocyanate, bearing at least one ionic or potentially ionic group, are mono- and dihydroxycarboxylic acids, mono- and diaminocarboxylic acids, mono- and dihydroxysulfonic acids, mono- and diaminosulfonic acids as well as mono- and dihydroxyphosphonic acids or mono- and diaminophosphonic acids and alkali metal and ammonium salts thereof. Examples are dimethylolpropionic acid, dimethylolbutyric acid, hydroxypivalic acid, N-(2-aminoethyl)-β-alanine, 2-(2-aminoethylamino)ethanesulfonic acid, ethylenediaminepropyl- or -butylsulfonic acid, propylene-1,2- or -1,3-diamine-β-ethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, Example 1) and the alkali metal and/or ammonium salts thereof; the adduct of sodium bisulfite onto but-2-ene-1,4-diol, polyethersulfonate, the propoxylated adduct of 2-butenediol and NaHSO₃, described, for example, in DE-A 2 446 440 (pages 5-9, formulae I-III). Well-suited for salt formation are hydroxides of sodium, potassium, lithium and calcium and teriary amines such as triethylamine, dimethylcyclohexylamine and ethyldiisopropylamine. Other amines can also be used for salt formation such as ammonia, diethanolamine, triethanolamine, dimethylethanolamine, methyldiethanolamine, aminomethylpropanol and also mixtures of the specified and also other amines. Expediently, these amines are added after the substantial conversion of the isocyanate groups.

Further suitable as component D) are units, such as N-methyldiethanolamine, that can be converted into cationic groups by addition of acids.

Particularly preferred components D) are those having carboxyl and/or carboxylate and/or sulfonate groups.

Very particular preference is given to the sodium salts of N-(2-aminoethyl)-2-aminoethanesulfonic acid and N-(2-aminoethyl)-2-aminoethanecarboxylic acid, especially N-(2-aminoethyl)-2-aminoethanesulfonic acid. Very particular preference is furthermore given to the salts of dimethylolpropionic acid.

Components E) reactive to isocyanate can be, for example, polyoxyalkylene ethers comprising at least one hydroxyl or amino group. The frequently used polyalkylene oxide polyether alcohols are accessible in a manner known per se by alkoxylation of suitable starter molecules. Alkylene oxides suitable for the alkoxylation reaction are especially ethylene oxide and propylene oxide, which can be used individually or even together in the alkoxylation reaction.

Further components E) reactive to isocyanate are, for example, monoamines, diamines and/or polyamines and mixtures thereof.

Examples of monoamines are aliphatic and/or alicyclic primary and/or secondary monoamines such as ethylamine, diethylamine, the isomeric propyl- and butylamines, higher linear aliphatic monoamines and cycloaliphatic monoamines such as cyclohexylamine. Further examples are aminoalcohols, i.e. compounds comprising amino and hydroxyl groups in one molecule, such as e.g. ethanolamine, N-methylethanolamine, diethanolamine or 2-propanolamine. Examples of diamines are 1,2-ethanediamine, 1,6-hexamethylenediamine, 1-amino-3,3,5-trimethyl-5-aminomethylcyclohexane (isophoronediamine), piperazine, 1,4-diaminocyclohexane and bis(4-aminocyclohexyl)methane. Further suitable are adipic acid dihydrazide, hydrazine and hydrazine hydrate. Further examples are aminoalcohols, i.e. compounds comprising amino and hydroxyl groups in one molecule, such as e.g. 1,3-diamino-2-propanol, N-(2-hydroxyethyl)ethylenediamine or N,N-bis(2-hydroxyethyl)ethylenediamine. Examples of polyamines are diethylenetriamine and triethylenetetramine.

In a preferred form of the invention, the polymer according to the invention for adjusting the molar mass comprises at least one monomaine and/or at least one diamine as component E) reactive to isocyanate.

The polymer comprising components A), B), C), D) and optionally E) is crystalline or semicrystalline after drying. The melting temperature is at least 40° C., preferably between 40 and 80° C., particularly preferably between 42 and 60° C. and especially preferably between 45 and 52° C. The heat of fusion is at least 10 J/g, preferably at least 20 J/g and particularly preferably at least 30 J/g.

For production of the aqueous polyurethane or polyurethane-urea dispersions according to the invention, it is possible to use all methods known from the prior art, such as emulsifier-shear force, acetone, prepolymer mixing, melt emulsification, ketimine and solid-state spontaneous dispersion methods or derivatives thereof. A summary of these methods can be found in Methoden der organischen Chemie [Methods of Organic Chemistry] (Houben-Weyl, Erweiterungs- and Folgebände zur 4. Auflage [Expansion and Supplementary Volumes for the 4th Edition], Volume E20, H. Bartl and J. Falbe, Stuttgart, N.Y., Thieme 1987, p. 1671-1682). Preference is given to the melt emulsification, prepolymer mixing and the acetone methods. Particular preference is given to the acetone method. The application and performance of the acetone method is known from the prior art and to those skilled in the art from EP 0 232 778 for example.

The adhesive compositions comprising the dispersions according to the invention may be used alone or with the binders, auxiliaries and aggregates known from coatings and adhesives technology, especially emulsifiers and light stabilizers such as UV absorbers and sterically hindered amines (HALS), also antioxidants, fillers and auxiliaries, e.g. antisettling agents, defoaming and/or wetting agents, flow control agents, reactive diluents, plasticizers, catalysts, auxiliary solvents and/or thickeners and additives such as pigments, dyes or matting agents for example. Tackifiers may also be added.

The additives can be added directly to the dispersions according to the invention prior to processing. However, it is also possible to add at least a portion of the additives before or during the dispersing of the binder.

The selection and the metered addition of these substances, which can be added to the individual components and/or to the whole mixture, are known in principle to those skilled in the art and may be determined without unduly high effort, tailored to the specific application, by simple preliminary experiments.

The present invention furthermore provides two-component (2K) adhesive compositions comprising the dispersions according to the invention and at least one crosslinker Preferred crosslinkers are isocyanates, carbodiimides and aziridines. Particularly preferred are isocyanates and carbodiimides with isocyanates being especially preferred.

The isocyanates are polyisocyanate compounds having at least two isocyanate groups per molecule. The polyisocyanate is added in this case prior to use (2K processing). In this case, preference is given to polyisocyanate compounds which are emulsifiable in water. These compounds are described, e.g. in EP-A 0 206 059, DE-A 31 12 117 or DE-A 100 24 624. The polyisocyanate compounds are used in an amount of 0.1 to 20% by weight, preferably 0.5 to 10% by weight, particularly preferably 1.5 to 6% by weight, based on the aqueous dispersion.

The carbodiimide crosslinkers are preferably carbodiimides which are dispersed, emulsified or dissolved in water or are dispersible, emulsifiable and/or soluble in water.

Preference is given to crosslinkers containing carbodiimide structures comprising an average of 3 to 20 and particularly preferably 4 to 8 carbodiimide structural units per molecule.

Such carbodiimide crosslinkers can be obtained, for example, by carbodiimidization of diisocyanates such as e.g. tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanatodicyclohexylpropane-(2,2), 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, optionally with concomitant use of monofunctional isocyanates such as e.g. stearyl isocyanate, phenyl isocyanate, butyl isocyanate, hexyl isocyanate or/and higher-functionality isocyanates such as trimers, uretdiones, allophanates, biurets of the exemplary diisocyanates mentioned and subsequent, simultaneous or even prior reaction with hydrophilizing components, e.g. mono- or difunctional polyethers based on ethylene oxide polymers or ethylene oxide/propylene oxide copolymers started with alcohols or amines.

Preferred carbodiimide crosslinkers are obtained by carbodiimidization of 1-isocyanato-3,3,5-trimethyl-5-isocyanatomethylcyclohexane and/or 4,4′-diisocyanatodicyclohexylmethane.

The use of mixed carbodiimides, which comprise, for example, carbodiimides based on different isocyanates, is also possible.

The adhesives are suitable for bonding any substrates such as e.g. paper, cardboard, wood, textiles, metal, plastics, leather or mineral materials.

The adhesives according to the invention are particularly suitable for bonding rubber materials such as e.g. natural and synthetic rubbers, various plastics such as polyurethanes, polyvinyl acetate, polyvinyl chloride, especially plasticizer-containing polyvinyl chloride. Particular preference is given to the use for bonding soles composed of these materials, especially those based on polyvinyl chloride, especially plasticizer-containing polyvinyl chloride or of polyethylene vinyl acetate or polyurethane elastomer foam, to shoe uppers composed of leather or synthetic leather.

Furthermore, the adhesives according to the invention are particularly suitable for bonding films based on polyvinyl chloride or plasticizer-containing polyvinyl chloride to wood.

The adhesives according to the invention can be processed by the known methods of adhesives technology with respect to the processing of aqueous dispersion adhesives. The adhesives according to the invention are particularly suitable for bonding substrates by the heat-activation method. In this case, the dispersion is applied to the substrate and, after completion of evaporation of the water, the adhesive layer is activated by heating, e.g. using an infrared radiator, and is converted into an adhesive state. The temperature at which the adhesive film is sticky is referred to as the activation temperature. In order to achieve a sufficiently rapid melting of the crystalline or semicrystalline segments in the adhesive polymer, an activation temperature significantly above the melting temperature is generally required.

Surprisingly, the adhesive dispersions according to the invention, in a process with simultaneous drying and activation at low temperatures in the range of 50° C., have improved tack values compared to the prior art. This advantage is not lost, even on cold storage at temperatures between 3° C. and 10° C., such as they frequently occur during transport and storage of the dispersions. Thus, they enable a maximally efficient, cost-effective and energy-saving adhesive process. The present invention likewise relates to the use of the adhesive dispersions according to the invention for producing adhesive composites by a process with simultaneous drying and activation at low temperatures in the range of 50° C.

An adhesive composite comprising substrates and sheetlike structures bonded using the dispersions according to the invention, is also a subject matter of the present application.

### EXAMPLES

The melting temperature and the enthalpy of fusion of the dried polymer were determined by means of Differential Scanning calorimetry (DSC):

In each case, dried polymer films were produced by pouring the dispersions into teflon bowls with subsequent seven-day drying at room temperature. From these films, pieces with a mass of 10 mg were cut out and placed in DSC crucibles which were then sealed with lids in the crucible sealing press. The crucibles were placed at RT in the measuring cell of the calorimeter and cooled to −100° C. This is followed by three heatings in the temperature range of −100° C. to +150° C. The heating rate was 20 K/min, cooled between the first and second heating run at 320 K/min, between the second and third at 20 K/min. The thermal coupling of cooling block and measuring cell was effected by purging with nitrogen; a compressor cooled the measuring cell. To determine the melting temperature and enthalpy of fusion, third heating was evaluated. The instrument used was a Pyris Diamond DSC calorimeter from Perkin-Elmer.

Determination of the crystalline fractions of the polymer in the polymer droplets of the dispersions on storage at room temperature (14 days) and after 24 h cold storage at 5° C. by means of Differential Scanning calorimetry (DSC):

The dispersions are measured without preconditioning during the course of heating from +10° C. to +70° C. at a heating rate of 20K/min (cooling rate 320K/min) using a Pyris Diamond DSC calorimeter from Perkin-Elmer. For this purpose, 10 mg of the dispensed dispersions are weighed into pressure-tight Al crucibles (liquid capsules) which are sealed with a lid in a crucible sealing press. The thermal coupling of cooling block and measuring cell was effected by purging with nitrogen.

Tack measurement of SBR substrates (SBR=styrene-butadiene rubber) after storage of the dispersions at room temperature (14 days) or 5° C. (24 hours, then 1 day at room temperature):

Tack measurement is a method for performance assessment of the adhesion properties of adhesives. Tack refers to the ability of a material to form an appreciable adhesion at low contact pressure and short contact time.

To this end, 2 strips of halogenated SBR substrates (20×96 mm) are mechanically roughened, wiped with methyl ethyl ketone (MEK) and dried for 3 minutes at 50° C. in the circulation drying cabinet. Subsequently, the strips are pasted with adhesive on a 20×75 mm surface area, dried in circulating air for 3 minutes at 50° C. and activated.

After activation, 2 strips in each case are pressed to each other immediately, and also after 2 and after 4 minutes, for 10 seconds at 1 bar pressure and then the initial peel strength directly measured with a tensile tester (rate 100 mm/min.).

### Example 1 (Inventive)

100 Mol % PDI (Based on the Isocyanate Component)

506.3 g of a polyester diol of 1,4-butanediol and adipic acid of OH number 50 having a melting temperature of 49° C. and an enthalpy of fusion of 80 J/g are dewatered at 110° C. and 15 mbar for 1 hour. 2.25 g of 1,4-butanediol and 56.2 g of pentamethylene diisocyanate (PDI) are added at 60° C. The mixture is stirred at 80° C. until an isocyanate content of 1.63% is reached. The reaction mixture is dissolved in 780 g of acetone and herein cooled to 50° C. Into the homogeneous solution is added a solution of 5.68 g of the sodium salt of N-(2-aminoethyl)-2-aminoethanesulfonic acid, 1.17 g of diethanolamine and 3.19 g of N-(2-hydroxyethyl)ethylenediamine in 66 g of water with vigorous stirring. After 30 minutes, the mixture is dispersed by addition of 515 g of water. After removal of the acetone by distillation, a stable aqueous polyurethane-polyurea dispersion is obtained having a solids content of 50.0% by weight and an average particle size of the dispersion phase, determined by laser correlation, of 195 nm.

Melting temperature of the dried polymer=46.0° C., enthalpy of fusion=37.1 J/g

No crystalline fractions in the polymer in the dispersion after cold storage (24 h at 5° C.)!

After cold storage: Tack and peel strength at unchanged high level remains after a period of 4 minutes (see Tables 1 and 2).

### Example 2 (Inventive)

75 Mol % PDI and 25 Mol % HDI (Based on the Isocyanate Component)

506.3 g of a polyester diol of 1,4-butanediol and adipic acid of OH number 50 having a melting temperature of 49° C. and an enthalpy of fusion of 80 J/g are dewatered at 110° C. and 15 mbar for 1 hour. 2.25 g of 1,4-butanediol, 42.2 g of pentamethylene diisocyanate (PDI) and 15.3 g of hexamethylene diisocyanate (HDI) are added at 60° C. The mixture is stirred at 80° C. until an isocyanate content of 1.61% is reached. The reaction mixture is dissolved in 782 g of acetone and herein cooled to 50° C. Into the homogeneous solution is added a solution of 5.68 g of the sodium salt of N-(2-aminoethyl)-2-aminoethanesulfonic acid, 1.17 g of diethanolamine and 3.19 g of N-(2-hydroxyethyl)ethylenediamine in 66 g of water with vigorous stirring. After 30 minutes, the mixture is dispersed by addition of 517 g of water. After removal of the acetone by distillation, a stable aqueous polyurethane-polyurea dispersion is obtained having a solids content of 50.2% by weight and an average particle size of the dispersion phase, determined by laser correlation, of 205 nm.

Melting temperature of the dried polymer=46.4° C., enthalpy of fusion=38.4 J/g

No crystalline fractions in the polymer in the dispersion after cold storage (24 h at 5° C.)!

After cold storage: Tack and peel strength at unchanged high level remains after a period of 4 minutes (see Tables 1 and 2).

### Example 3 (Inventive)

50 Mol % PDI and 50 Mol % HDI (Based on the Isocyanate Component)

506.3 g of a polyester diol of 1,4-butanediol and adipic acid of OH number 50 having a melting temperature of 49° C. and an enthalpy of fusion of 80 J/g are dewatered at 110° C. and 15 mbar for 1 hour. 2.25 g of 1,4-butanediol, 28.1 g of pentamethylene diisocyanate (PDI) and 30.6 g of hexamethylene diisocyanate (HDI) are added at 60° C. The mixture is stirred at 80° C. until an isocyanate content of 1.59% is reached. The reaction mixture is dissolved in 783 g of acetone and herein cooled to 50° C. Into the homogeneous solution is added a solution of 5.68 g of the sodium salt of N-(2-aminoethyl)-2-aminoethanesulfonic acid, 1.17 g of diethanolamine and 3.19 g of N-(2-hydroxyethyl)ethylenediamine in 66 g of water with vigorous stirring. After 30 minutes, the mixture is dispersed by addition of 518 g of water. After removal of the acetone by distillation, a stable aqueous polyurethane-polyurea dispersion is obtained having a solids content of 50.1% by weight and an average particle size of the dispersion phase, determined by laser correlation, of 199 nm (see Tables 1 and 2).

Melting temperature of the dried polymer=46.6° C., enthalpy of fusion=37.8 J/g

No crystalline fractions in the polymer in the dispersion after cold storage (24 h at 5° C.)!

After cold storage: Tack and peel strength at unchanged high level remains after a period of 4 minutes (see Tables 1 and 2).

### Example 4 (Comparative)

25 Mol % PDI and 75 Mol % HDI (Based on the Isocyanate Component)

506.3 g of a polyester diol of 1,4-butanediol and adipic acid of OH number 50 having a melting temperature of 49° C. and an enthalpy of fusion of 80 J/g are dewatered at 110° C. and 15 mbar for 1 hour. 2.25 g of 1,4-butanediol, 14.1 g of pentamethylene diisocyanate (PDI) and 46.0 g of hexamethylene diisocyanate (HDI) are added at 60° C. The mixture is stirred at 80° C. until an isocyanate content of 1.66% is reached. The reaction mixture is dissolved in 785 g of acetone and herein cooled to 50° C. Into the homogeneous solution is added a solution of 5.68 g of the sodium salt of N-(2-aminoethyl)-2-aminoethanesulfonic acid, 1.17 g of diethanolamine and 3.19 g of N-(2-hydroxyethyl)ethylenediamine in 66 g of water with vigorous stirring. After 30 minutes, the mixture is dispersed by addition of 519 g of water. After removal of the acetone by distillation, a stable aqueous polyurethane-polyurea dispersion is obtained having a solids content of 50.1% by weight and an average particle size of the dispersion phase, determined by laser correlation, of 206 nm.

Melting temperature of the dried polymer=46.3° C., enthalpy of fusion=38.2 J/g

Crystalline fractions detectable by DSC in the polymer in the dispersion after cold storage (24 h at 5° C.), melting temperature 44.5° C., enthalpy of fusion 7.6 J/g.

After cold storage: Tack and peel strength drops significantly over a period of 4 minutes since the crystalline fractions in the polymer present in the dispersion on activation at 50° C. are not fully melted (see Tables 1 and 2)!

### Example 5 (Comparative)

100 Mol % HDI (Based on the Isocyanate Component)

506.3 g of a polyester diol of 1,4-butanediol and adipic acid of OH number 50 having a melting temperature of 49° C. and an enthalpy of fusion of 80 J/g are dewatered at 110° C. and 15 mbar for 1 hour. 2.25 g of 1,4-butanediol and 61.3 g of hexamethylene diisocyanate (HDI) are added at 60° C. The mixture is stirred at 80° C. until an isocyanate content of 1.68% is reached. The reaction mixture is dissolved in 787 g of acetone and herein cooled to 50° C. Into the homogeneous solution is added a solution of 5.68 g of the sodium salt of N-(2-aminoethyl)-2-aminoethanesulfonic acid, 1.17 g of diethanolamine and 3.19 g of N-(2-hydroxyethyl)ethylenediamine in 66 g of water with vigorous stirring. After 30 minutes, the mixture is dispersed by addition of 520 g of water. After removal of the acetone by distillation, a stable aqueous polyurethane-polyurea dispersion is obtained having a solids content of 50.0% by weight and an average particle size of the dispersion phase, determined by laser correlation, of 200 nm.

Melting temperature of the dried polymer=48.3° C., enthalpy of fusion=37.6 J/g

Crystalline fractions present in the polymer in the dispersion after cold storage (24 h at 5° C.), melting temperature 40.1° C., enthalpy of fusion 11.4 J/g.

After cold storage: Tack and peel strength drops significantly over a period of 4 minutes since the crystalline fractions in the polymer present in the dispersion on activation at 50° C. are not fully melted (see Tables 1 and 2)!

| Initial peel strength | | | | Ex. 4 | Ex. 5 |
|---|---|---|---|---|---|
| [N/mm], adhesive | Ex. 1 | Ex. 2 | Ex. 3 | comparative | comparative |
| bonding after drying | (after RT | (after RT | (after RT | (after RT | (after RT |
| and activation | storage) | storage) | storage) | storage) | storage) |
| immediately | 2.1 | 1.5 | 1.6 | 1.4 | 2.0 |
| after 2 min. | 1.6 | 1.8 | 1.7 | 1.6 | 1.8 |
| after 4 min. | 1.9 | 1.7 | 1.6 | 1.8 | 1.8 |

| Initial peel strength | Ex. 1 | Ex. 2 | Ex. 3 | Ex. 4 | Ex. 5 |
|---|---|---|---|---|---|
| [N/mm], adhesive | (after | (after | (after | comparative | comparative |
| bonding after drying | storage at | storage at | storage at | (after storage | (after storage |
| and activation | 5° C.) | 5° C.) | 5° C.) | at 5° C.) | at 5° C.) |
| immediately | 1.8 | 1.6 | 1.6 | 1.4 | 1.0 |
| after 2 min. | 1.5 | 1.5 | 1.7 | 0.8 | 0.5 |
| after 4 min. | 1.8 | 1.5 | 1.8 | 0.7 | 0.2 |

1.-16. (canceled)

17. Preparations comprising aqueous polyurethane or polyurethane-urea dispersions comprising a corresponding polymer composed of
A) at least one crystalline or semicrystalline difunctional polyester polyol having a number-average molecular weight of at least 400 g/mol and a melting temperature of at least 40° C. and a heat of fusion of at least 20 J/g,
B) optionally at least one difunctional polyol component having a number-average molecular weight of 62 to 399 g/mol,
C) an isocyanate component consisting of pentamethylene diisocyanate or a mixture of pentamethylene diisocyanate and hexamethylene diisocyanate with at least 50 mol % pentamethylene diisocyanate,
D) at least one component reactive to isocyanate bearing at least one ionic or potentially ionic group,
and
E) optionally further components reactive to isocyanate
wherein the polymer after drying is crystalline or semicrystalline and has a melting temperature of at least 40° C. and a heat of fusion of at least 10 J/g.

18. Preparations according to claim 17, wherein the aqueous dispersions comprise 15 to 60% by weight polymer and 40 to 85% by weight water.

19. Preparations according to claim 17, wherein the aqueous dispersions comprise 30 to 50% by weight polymer and 50 to 70% by weight water.

20. Preparations according to claim 17, wherein the aqueous dispersions comprise 40 to 50% by weight polymer and 50 to 60% by weight water.

21. Preparations according to claim 17, wherein the polymer comprises 50 to 95% by weight of constituent A), 0 to 10% by weight of constituent B), 4 to 25% by weight of constituent C), 0.5 to 10% by weight of constituent D) and 0 to 30% by weight of constituent E), wherein the sum total of the constituents adds up to 100% by weight.

22. Preparations according to claim 17, wherein the polymer comprises 65 to 92% by weight of constituent A), 0 to 5% by weight of constituent B), 6 to 15% by weight of constituent C), 0.5 to 5% by weight of constituent D) and 0 to 25% by weight of constituent E), wherein the sum total of the constituents adds up to 100% by weight.

23. Preparations according to claim 17, wherein the polymer comprises 75 to 92% by weight of constituent A), 0 to 5% by weight of constituent B), 8 to 15% by weight of constituent C), 0.5 to 4% by weight of constituent D) and 0 to 15% by weight of constituent E), wherein the sum total of the constituents adds up to 100% by weight.

24. Preparations according to claim 17, wherein the polymer comprises 80 to 90% by weight of constituent A), 0 to 3% by weight of constituent B), 8 to 14% by weight of constituent C), 0.5 to 3% by weight of constituent D) and 0 to 10% by weight of constituent E), wherein the sum total of the constituents adds up to 100% by weight.

25. Preparations according to claim 17, wherein said preparations comprise as additional component one or more crosslinkers, preferably isocyanates, carbodiimides and/or aziridines, particularly preferably isocyanates and carbodiimides, especially preferably isocyanates.

26. Use of the preparations according to claim 17 as heat-activated adhesives.

27. Adhesive composites comprising substrates bonded with the preparations according to claim 17.

28. Adhesive composites according to claim 27, wherein they take the form of bonded sheetlike structures.

29. Adhesive composites according to claim 27, wherein the bonded sheetlike structures are footwear soles composed of rubber materials or plastics bonded to shoe uppers composed of leather and synthetic leather.

30. Substrates bonded with preparations according to claim 17.

31. Process for adhesive bonding of substrates in which a preparation according to claim 17 for producing an adhesive layer is applied to the substrate(s) to be bonded; after completion of evaporation or during evaporation of the water the adhesive layer thus obtained is activated by heating to at least the activation temperature of the layer and melting of the semicrystalline polymer and the substrate(s) are then joined.

32. Process according to claim 31 in which a preparation according to claim 17 for producing an adhesive layer is applied to the substrate(s) to be bonded; the drying and activation is effected simultaneously in one step at low temperatures in the range of 50° C. and the substrate(s) are then joined.
